(19) United States
(12) Patent Application Publication
(10) Pub. No.: US 2026/0251948 A1
(43) Pub. Date: Aug. 27, 2026

(54) ELECTRONIC DEVICE

(71) Applicant: LG Display Co., Ltd., Seoul (KR)

(72) Inventors: Jungim HWANG, Paju-si (KR); Taewoon KO, Paju-si (KR)

(21) Appl. No.: 19/441,914

(22) Filed: Jan. 7, 2026

(30) Foreign Application Priority Data
Feb. 25, 2025 (KR) 10-2025-0024361

(51) Int. Cl. G02F 1/29

(52) U.S. Cl. CPC G02F 1/29; G02F 2201/122

(57) ABSTRACT

An electronic device including a display device and a lens structure configured to change the light output from the display device, and the lens structure includes a first electrode, a second electrode facing the first electrode, and a plurality of liquid crystals between the first electrode and the second electrode.

### CROSS REFERENCE TO RELATED APPLICATION

This application claims priority from and the benefit of Korean Patent Application No. 10-2025-0024361, filed on February 25, 2025, which is hereby incorporated by reference for all purposes as if fully set forth herein.

### BACKGROUND

### Field

Embodiments of the invention relate to an electronic device.

### Discussion of the Background

Wearable electronic devices, such as augmented reality glasses (AR glasses), virtual reality (VR) devices, video see-through (VST) devices, and extended reality (XR) devices, including head-mounted displays (HMDs), are wearable devices that enable virtual reality (VR), augmented reality (AR), and mixed reality (MR) experiences. These devices are comprised of displays, optical systems, various sensors, and processors.

Users can experience immersive virtual environments or receive real-time digital information superimposed on the real world. Telecommunication service providers and electronic device manufacturers are competitively developing these devices to offer diverse features and differentiate themselves from competitors. Consequently, the various functions offered by wearable electronic devices are also becoming increasingly sophisticated.

The above information disclosed in this Background section is only for understanding of the background of the inventive concepts, and, therefore, it may contain information that does not constitute prior art.

### SUMMARY

Embodiments of the invention provide an electronic device that can adjust the focal length.

Embodiments of the invention provide an electronic device that can correct vision.

Embodiments of the invention provide an electronic device that does not lose brightness.

Embodiments of the invention provide a slim electronic device in terms of thickness.

Embodiments of the invention provide a low-power electronic device.

Additional features of the inventive concepts will be set forth in the description which follows, and in part will be apparent from the description, or may be learned by practice of the inventive concepts.

According to embodiments of the invention, the electronic device includes a display device; and a lens structure configured to change the light output from the display device. The lens structure may include a first electrode, a second electrode facing the first electrode, and a plurality of liquid crystals between the first electrode and the second electrode.

The lens structure may include a first lens structure including the first electrode, the second electrode, and the capsule structure, the first lens structure may include a first variable layer disposed between the first electrode and the second electrode, and the first variable layer may include the capsule structure.

The first electrode, the second electrode, and the first variable layer may further include a first hole formed therein, and a first non-variable layer disposed in an area at least partially overlapping the first hole.

The first electrode may have a circular ring shape surrounding the periphery of the first hole.

The first non-variable layer may include a capsule structure including a plurality of liquid crystals.

The plurality of liquid crystals of the first variable layer may be aligned in a direction perpendicular to the first electrode.

When the first voltage is not applied to the first electrode, the plurality of liquid crystals of the first variable layer may be randomly aligned.

The refractive index of the first variable layer may be lower than the refractive index of the first non-variable layer.

The electronic device may further include a second lens structure, and the second lens structure may include a capsule structure including a third electrode, a fourth electrode, and a plurality of liquid crystals between the third electrode and the fourth electrode, and it may further include a second variable layer between the third electrode and the fourth electrode, a second hole is formed in the third electrode, the fourth electrode, and the second variable layer, and a second non-variable layer may be disposed in the second hole.

The electronic device may further include an insulating layer, and the insulating layer may be disposed between the first lens structure and the second lens structure.

The second electrode and the fourth electrode may be electrically connected.

According to embodiments of the invention, an electronic device includes a display device; and a lens structure configured to change the light output from the display device. The lens structure may include a first electrode comprising a 1-1 electrode, a 1-2 electrode, and a 1-3 between the 1-1 electrode and the 1-2 electrode, the 1-1, 1-2, and 1-3 electrodes are located on the same line; a second electrode comprising a 1-2 electrode facing the 1-1 electrode, a 2-2 electrode facing the 1-2 electrode, and a 2-3 electrode facing the 1-3 electrode; and a resin layer comprising a capsule structure comprising a plurality of liquid crystals between the first electrode and the second electrode.

The 1-1 electrode and the 1-2 electrode may be electrically connected, and the 2-1 electrode and the 2-2 electrode may be electrically connected.

The 1-3 electrode may not be electrically connected to the 1-1 electrode, the 1-2 electrode, and the 2-3 electrode, and the 2-3 electrode may not be electrically connected to the 2-1 electrode and the 2-2 electrode.

The electronic device may further include a first insulating layer; and a third electrode, and the first insulating layer may be disposed on the first electrode, the third electrode may be disposed on the first insulating layer, and the third electrode may be electrically connected to the first-third electrode.

The electronic device may further include a second insulating layer; and a fourth electrode. The second insulating layer may be disposed on the second electrode, the fourth electrode may be disposed on the second insulating layer, and the fourth electrode may be electrically connected to the second-third electrode.

When voltage is applied to the 1-1 electrode, the 2-1 electrode, the third electrode, and the fourth electrode, the refractive index of the resin layer may become lower than before the voltage is applied.

When voltage is applied to the 1-1 electrode and the 2-1 electrode and no voltage is applied to the third electrode and the fourth electrode, the refractive index of the resin layer between the 1-1 electrode and the 2-1 electrode, and the refractive index of the resin layer between the 1-2 electrode and the 2-2 electrode may be lower than the refractive index of the resin layer between the 1-3 electrode and the 2-3 electrode.

When no voltage is applied to the 1-1 electrode and the 2-1 electrode and a voltage is applied to the third electrode and the fourth electrode, the refractive index of the resin layer between the 1-1 electrode and the 2-1 electrode, and the refractive index of the resin layer between the 1-2 electrode and the 2-2 electrode may be higher than the refractive index of the resin layer between the 1-3 electrode and the 2-3 electrode.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is a perspective view of an electronic device according to an embodiment of the invention.

FIG. 2 is a schematic plan view of the display system according to FIG. 1.

FIG. 3 is a schematic plan view of the lens structure according to FIG. 1.

FIG. 4 is a perspective view of the lens structure according to FIG. 1.

FIG. 5 is a cross-sectional view taken along line A-A' of FIG. 4.

FIG. 6 is a cross-sectional view taken along line A-A' of FIG. 4.

FIG. 7 is a cross-sectional view of a lens structure according to an embodiment of the invention.

FIG. 8 is a cross-sectional view of a lens structure according to an embodiment of the invention.

FIG. 9 is a cross-sectional view of a lens structure according to an embodiment of the invention.

FIG. 10 is a cross-sectional view showing the alignment of liquid crystals in the lens structure according to FIG. 9.

FIG. 11 is a cross-sectional view showing the alignment of liquid crystals in the lens structure according to FIG. 9.

FIG. 12 is a cross-sectional view showing the alignment of liquid crystals in the lens structure according to FIG. 9.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z – axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As is customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

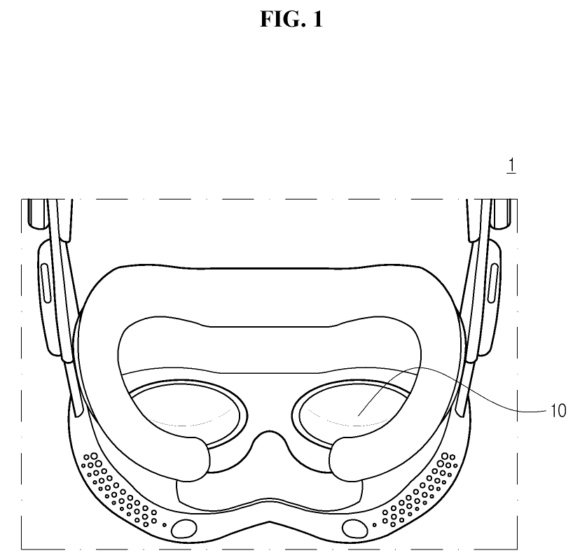

FIG. 1 is a perspective view of an electronic device according to embodiments of the invention.

Referring to FIG. 1, the electronic device 1 according to embodiments of the invention may be a wearable device that may be worn by a user, such as augmented reality glasses (AR glasses), a head-mounted device (HMD), a virtual reality (VR) device, and a video see-through (VST) device, without being limited thereto.

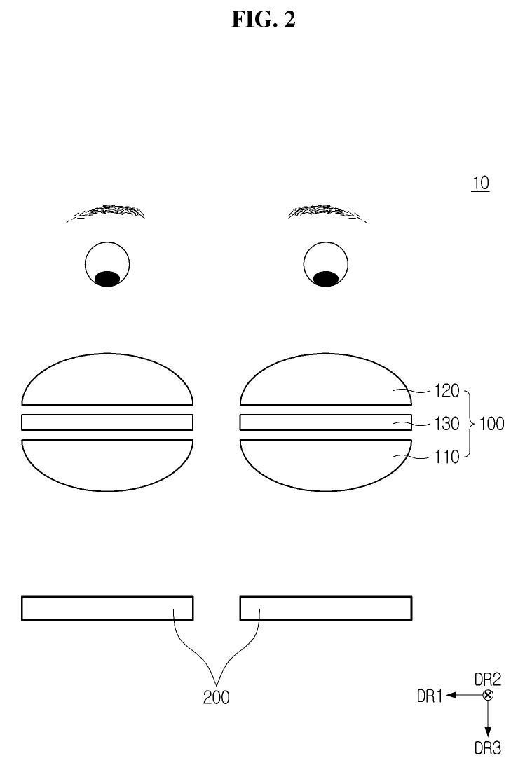

The electronic device 1 according to embodiments of the invention may include a display system 10. Although not illustrated, the display system 10 may include a display device (see 200 of FIG. 2) to output an image, and a lens structure (see 100 of FIG. 2) through which an image output from the display device is transmitted to the user.

FIG. 2 is a schematic plan view of the display system according to FIG. 1.

Referring to FIG. 2, the display system 10 may include a display device 200 and a lens structure 100.

As used herein, the first direction (DR1) and the second direction (DR2) are different directions and represent mutually intersecting directions, for example, directions that intersect perpendicularly in a plan view. The third direction (DR3) represents a direction that intersects a plane on which the first direction (DR1) and the second direction (DR2) are located, for example, a direction that perpendicularly intersects both the first direction (DR1) and the second direction (DR2). In FIG. 2, the third direction (DR3) may be the same as the stacking direction of the first lens structure 110, the second lens structure 120, and the insulating layer 130. However, it should be understood that the directions mentioned in the embodiments of the invention refer to relative directions, and the embodiments of the invention are not limited to the mentioned directions.

The display device 200 may output an image, and the display device 200 may include at least one of a liquid crystal display (LCD), a digital mirror device (DMD), a liquid crystal on silicon (LCoS), an organic light emitting diode (OLED), or a micro light emitting diode (micro LED), without being limited thereto.

The lens structure 100 may be placed between the display device 200 and the user, and thus, an image output from the display device 200 may be transmitted to the user through the lens structure 100.

The lens structure 100 may include a first lens structure 110, a second lens structure 120, and an insulating layer 130. The first lens structure 110 may be placed at a position closest to the display device 200 based on the third direction (DR3), the second lens structure 120 may be placed at a position opposite to the first lens structure 110 and adjacent to the user, and the insulating layer 130 may be placed between the first lens structure 110 and the second lens structure 120.

The first lens structure 110 and the second lens structure 120 may each include a capsule structure including two electrodes and a plurality of liquid crystals between the two electrodes.

The first lens structure 110 may perform a function of adjusting the focal length of an image output from the display device 200, and the second lens structure 120 may perform a function of correcting the user's eyesight. However, embodiments of the invention are not limited thereto, and the first lens structure 110 may correct the user's eyesight, and the second lens structure 120 may adjust the focal length.

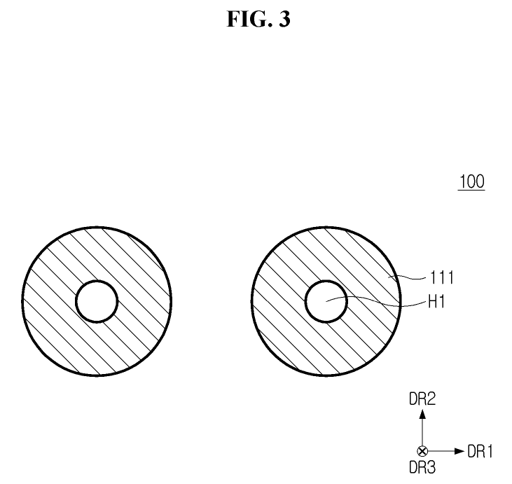

FIG. 3 is a schematic plan view of the lens structure according to FIG. 1.

Referring to FIG. 3, the first lens structure 110 may include a first electrode 111, and the first electrode 111 may have a circular shape when viewed in a plane where the first direction (DR1) and the second direction (DR2) intersect. However, the embodiments of the invention are not limited thereto, and the first electrode 111 may have, for example, an oval, a square, a rectangle, a rectangle with rounded corners, or other polygonal shapes.

A first hole (H1) may be formed at the center of the first lens structure 110. Accordingly, the first electrode 111 may have a circular ring shape surrounding the perimeter of the first hole (H1).

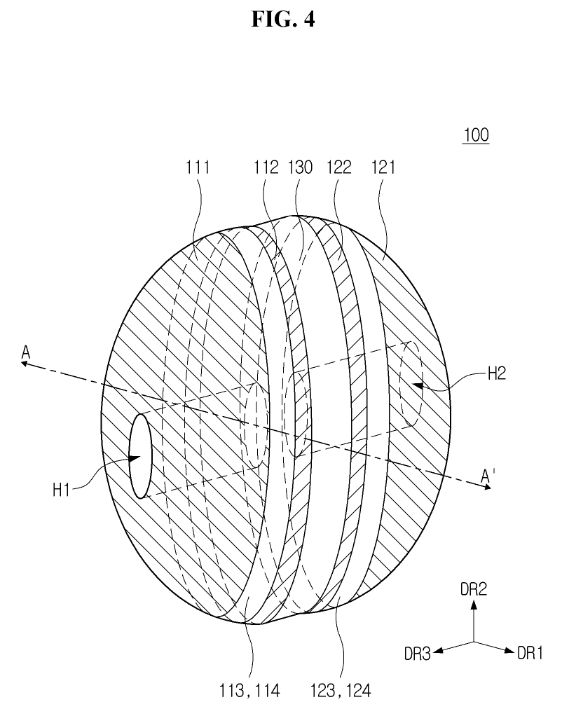

FIG. 4 is a perspective view of the lens structure according to FIG. 1.

Referring to FIG. 4, the lens structure 100 may have a spherical shape. However, the embodiments of the invention are not limited thereto, and the lens structure 100 may have, for example, a three-dimensional shape such as an oval, a cube, or a rectangular parallelepiped.

The first lens structure 110 may include a first electrode 111, a second electrode 112, and a first variable layer 113 and 114 disposed therebetween, and the second lens structure 120 may include a third electrode 121, a fourth electrode 122, and a second variable layer 123 and 124 disposed therebetween, and an insulating layer 130 may be disposed between the first lens structure 110 and the second lens structure 120.

The first hole (H1) may be formed in the first lens structure 110, and a second hole (H2) may be formed in the second lens structure 120. The first hole (H1) and the second hole (H2) may be formed parallel to the user's viewing direction. Although the first hole (H1) and the second hole (H2) are illustrated as being positioned on the same line with respect to the third direction (DR3) in the drawing, embodiments of the invention are not limited thereto, and they may be formed on different lines.

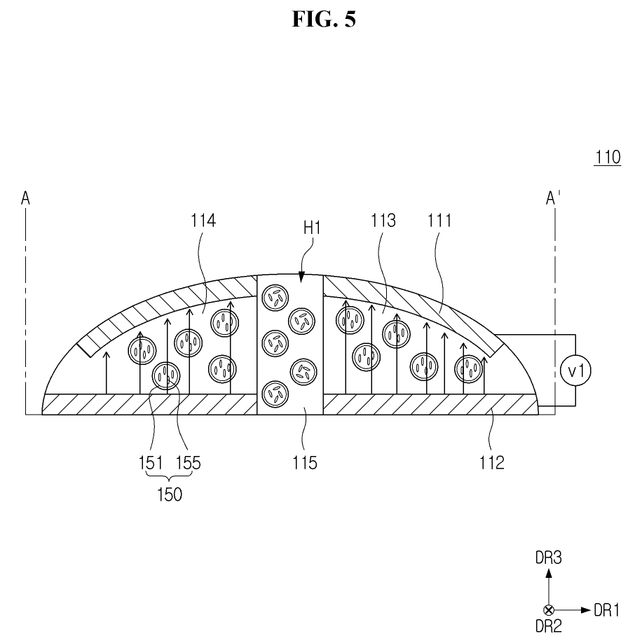

FIG. 5 is a cross-sectional view taken along line A-A' of FIG. 4.

Referring to FIG. 5, FIG. 5 is a cross-sectional view of the lens structure 100 illustrated in FIG. 4 taken along a plane formed by the first direction (DR1) and the third direction (DR3), and is a cross-sectional view taken to pass through the center points of the first hole (H1) and the second hole (H2). FIG. 5 illustrates only the cross-section of the first lens structure 110.

FIG. 5 exemplifies a case where a first voltage is applied to the first lens structure 110. The first lens structure 110 may include a first electrode 111, a second electrode 112, first variable layers 113 and 114, a first non-variable layer 115, a first voltage (V1), a capsule structure 150, and a first hole (H1).

The first electrode 111 may be a transparent electrode that transmits light. The first electrode 111 may include a transparent conductive material such as ITO (Indium Tin Oxide), IZO (Indium Zinc Oxide), or ITZO (Indium Tin Zinc Oxide), or metal that transmits visible light, but embodiments of the invention are not limited thereto. The first electrode 111 may have a shape of a curve with a convex center when viewed on a plane where the first direction (DR1) and the third direction (DR3) intersect, and may have a dome shape in a three-dimensional plane, as illustrated in FIG. 4. However, embodiments of the invention are not limited thereto, and may have, for example, a straight shape.

The second electrode 112 may be a transparent electrode that transmits light. The second electrode 112 may include a transparent conductive material such as ITO (Indium Tin Oxide), IZO (Indium Zinc Oxide), or ITZO (Indium Tin Zinc Oxide), or metal that transmits visible light, but embodiments of the invention are not limited thereto. The second electrode 112 may have a straight shape when viewed on a plane where the first direction (DR1) and the third direction (DR3) intersect.

Although the first electrode 111 and the second electrode 112 are depicted as being separated from each other by the first hole (H1) in the drawing, they may have a structure in which they are integrally connected in a circular ring shape surrounding the first hole (H1), as described in FIG. 4. More particularly, the first electrode 111 may have a ring shape surrounding the first hole (H1), and the second electrode 112 may have another ring shape surrounding the first hole (H1).

The first electrode 111 may be arranged to face the second electrode 112. The first variable layers 113 and 114 may be arranged between the first electrode 111 and the second electrode 112, and the first variable layers 113 and 114 may be in direct contact with the first electrode 111 and the second electrode 112, respectively.

The first variable layers 113 and 114 may include a first-first variable layer 113 and a first-second variable layer 114. The first-first variable layer 113 and the first-second variable layer 114 may include an organic material or resin and may be transparent or translucent to at least partially transmit light entering the first variable layers 113 and 114. A capsule structure 150 may be disposed in each of the first-first variable layer 113 and the first-second variable layer 114. Although it is described that the capsule structure 150 is disposed in each of the first-first variable layer 113 and the first-second variable layer 114, it may alternatively be described that the first-first variable layer 113 and the first-second variable layer 114 include the capsule structure 150. In general, any of the variable layers and non-variable layers described below may have capsule structures disposed thereon or may include capsule structures. The first variable layers 113 and 114 may serve to bind the capsule structures 150 disposed on the first variable layers 113 and 114. As described in FIG. 4, the first-first variable layer 113 and the first-second variable layer 114 may be integrally connected in a circular ring shape surrounding a first hole (H1).

The first hole (H1) may penetrate the first electrode 111, the second electrode 112, and the first variable layers 113 and 114 in the third direction (DR3). In some embodiments, the first hole (H1) may completely penetrate the first electrode 111, the second electrode 112, and the first variable layer 113 and 114.

The first non-variable layer 115 may be arranged in the first hole (H1). The first non-variable layer 115 may at least partially fill the first hole (H1), and the upper and lower surfaces of the first non-variable layer 115 may be exposed to the outside. In some embodiments, the first non-variable layer 115 may completely fill the first hole (H1). The first non-variable layer 115 may be in direct contact with the adjacent first electrode 111, second electrode 112, and first variable layers 113 and 114. The first non-variable layer 115 may include an organic material or resin, and may be transparent or translucent to at least partially transmit light entering the first non-variable layer 115. The capsule structure 150 may be disposed on the first non-variable layer 115, and thus, the first non-variable layer 115 may serve to bind the capsule structure 150 disposed on the first non-variable layer 115.

The capsule structure 150 may include a liquid crystal capsule 151 and liquid crystal molecules 155, and may be provided in multiple units. The liquid crystal molecules 155 may be provided in multiple units, and the liquid crystal capsule 151 may surround a plurality of liquid crystal molecules 155. The liquid crystal capsule 151 may be a polymer capsule having a diameter of several to several hundred nanometers, and may be made of a water-soluble material such as polyvinyl alcohol (PVA) or a fat-soluble material such as polymethyl methacrylate (PMMA), without being limited thereto. The liquid crystal molecules 155 may be positive liquid crystal molecules, but embodiments of the invention are not limited thereto.

In the first variable layers 113 and 114 disposed between the first electrode 111 and the second electrode 112, the alignment direction of the liquid crystal molecules 155 of the capsule structure 150 may vary depending on the voltage applied to the first electrode 111 and the second electrode 112. For example, a first voltage (V1) may be applied to the first electrode 111, and a voltage lower than the voltage of the first electrode 111, for example, a ground voltage (0 V) may be applied to the second electrode 112. When voltages are applied to electrodes 111 and 112 in this manner, the liquid crystal molecules 155 of the first variable layers 113 and 114 may be aligned parallel to the electric field. Alternatively, the liquid crystal molecules 155 of the first variable layers 113 and 114 may be aligned along the third direction (DR3), which may be the direction perpendicular to the second electrode 112, when the voltage is applied.

The refractive index of the first variable layers 113 and 114 may be derived by adding the refractive index of the first variable layers 113 and 114 itself and the refractive index of the capsule structure 150 arranged in the first variable layers 113 and 114. When voltage is applied to the first electrode 111 and the second electrode 112, the alignment direction of the liquid crystal molecules 155 arranged in the capsule structure 150 becomes more parallel to the direction of propagation of the incoming light, and thus the refraction of the light path by the liquid crystal molecules 155 may be reduced, and consequently, the refractive index of the first variable layers 113 and 114 may be lowered. Therefore, the refractive index of the first variable layers 113 and 114 may be controlled depending on the magnitude of the voltage applied to the first electrode 111 and the second electrode 112.

Since the first non-variable layer 115 is not affected by voltage, the liquid crystal molecules 155 in the first non-variable layer 115 may be randomly aligned. Therefore, when voltage is applied to the first electrode 111 and the second electrode 112, the refractive index of the first variable layers 113 and 114 may become lower than that of the first non-variable layer 115.

By adjusting the voltage of the first electrode 111 and the second electrode 112 by their positions, the refractive index of the first variable layers 113 and 114 can be changed by their positions, thereby controlling the focal length of light incident on the first lens structure 110.

When wearing an XR device, a discrepancy may occur between the image output from the display device 200 and the image in actual reality, which could in some cases lead to a sense of dizziness for some users. In this case, the sense of dizziness can be alleviated by adjusting the focal length of the first lens structure 110.

Although not shown, the electronic device 1 may include a sensor that performs eye tracking or hand tracking, and may adjust the focal length based on information collected through the sensor.

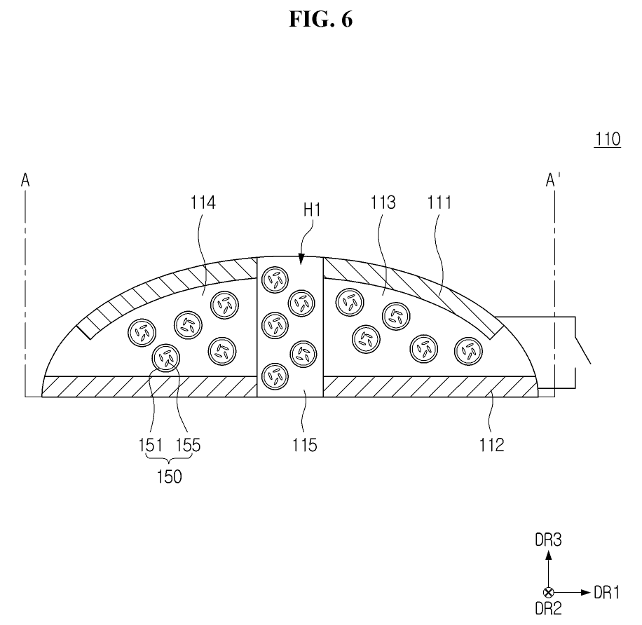

FIG. 6 is a cross-sectional view taken along line A-A' of FIG. 4.

Referring to FIG. 6, FIG. 6 illustrates a case where no voltage is applied to the first lens structure 110. When no voltage is applied to the first electrode 111 and the second electrode 112, the liquid crystal molecules 155 of the first variable layers 113 and 114 may be randomly aligned, compared to when voltage is applied.

In the case of the first non-variable layer 115, since it is not affected by voltage, the liquid crystal molecules 155 of the first non-variable layer 115 may be randomly aligned. Accordingly, the refractive index of the first variable layers 113 and 114 may be substantially the same as the refractive index of the first non-variable layer 115.

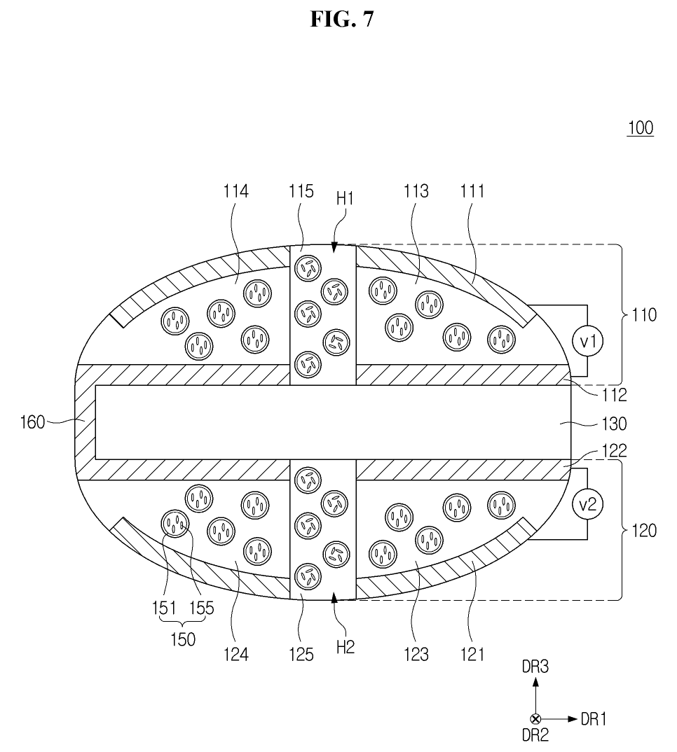

FIG. 7 is a cross-sectional view of a lens structure according to embodiments of the invention.

Referring to FIG. 7, the lens structure 100 may include a first lens structure 110, a second lens structure 120, an insulating layer 130 therebetween, and a connecting electrode 160.

The first lens structure 110 and the second lens structure 120 may be arranged symmetrically with respect to the first direction (DR1). The first lens structure 110 has been described above with reference to FIG. 5, and thus a detailed description thereof will be omitted.

The second lens structure 120 may include a third electrode 121, a fourth electrode 122, second variable layer 123 and 124s, a second non-variable layer 125, a second hole (H2), a second voltage (V2), and a capsule structure 150. The second lens structure 120 is substantially identical to the first lens structure 110 described above in FIG. 5, and thus a detailed description thereof will be omitted.

The insulating layer 130 may be a non-conductive material and may be disposed between the second electrode 112 and the fourth electrode 122 to block an electric field so that the two electrodes are not affected by voltage. The insulating layer 130 may be transparent or translucent to at least partially transmit light entering the insulating layer 130.

The connecting electrode 160 may be disposed on one side of the first direction (DR1) of the insulating layer 130 and may be electrically connected to the second electrode 112 and the fourth electrode 122. Accordingly, when a voltage is applied to the second electrode 112, the same voltage may also be applied to the connection electrode 160 and the fourth electrode 122.

The first electrode 111 and the second electrode 112 may be electrically connected to a first voltage (V1), and the third electrode 121 and the fourth electrode 122 may be electrically connected to a second voltage (V2). The magnitude of the voltage applied by the first voltage (V1) may be substantially the same as the magnitude of the voltage applied by the second voltage (V2). However, the embodiments of the invention are not limited thereto, and for example, the magnitude of the voltage applied by the first voltage (V1) may be greater than the magnitude of the voltage applied by the second voltage (V2).

When voltage is applied to the first electrode 111, the second electrode 112, the third electrode 121, and the fourth electrode 122, the liquid crystal molecules 155 arranged in the first variable layers 113 and 114 and the second variable layers 123 and 124 may be aligned parallel to the third direction (DR3). Accordingly, the refractive index of the first variable layers 113 and 114 and the second variable layers 123 and 124 may be lowered than before the voltage is applied.

The liquid crystal molecules 155 arranged in the first non-variable layer 115 and the second non-variable layer 125 may be randomly aligned, and thus, the refractive index of the non-variable layers 115 and 125 may be higher than the refractive index of the variable layers 113, 114, 123, and 124.

Pancake lenses, which are commonly used as lenses for existing XR devices, have the problem of reducing the brightness of light output from the display device 200 due to the use of polarizing plates. Furthermore, focus-variable lenses have the problem of increasing the thickness. Furthermore, users with poor eyesight must wear separate corrective lenses when wearing the XR device, resulting in increased thickness.

According to embodiments of the invention, the lens structure 100 may adjust the voltage applied to the lens to change the refractive index of nano-sized capsule liquid crystals, thereby performing focal length and vision correction. Therefore, since a polarizing plate is not used, the brightness of light output from the display device 200 may not be reduced, and the display device can be slimmed down.

Furthermore, since the lens structure 100 includes a first lens structure 110 and a second lens structure 120, in which the first lens structure 110 is used for focal length adjustment, and the second lens structure 120 is used for vision correction, thereby integrating the focal length adjustment lens and the vision correction lens into one, the display device employing the lens structure 100 according to embodiments may be formed slim.

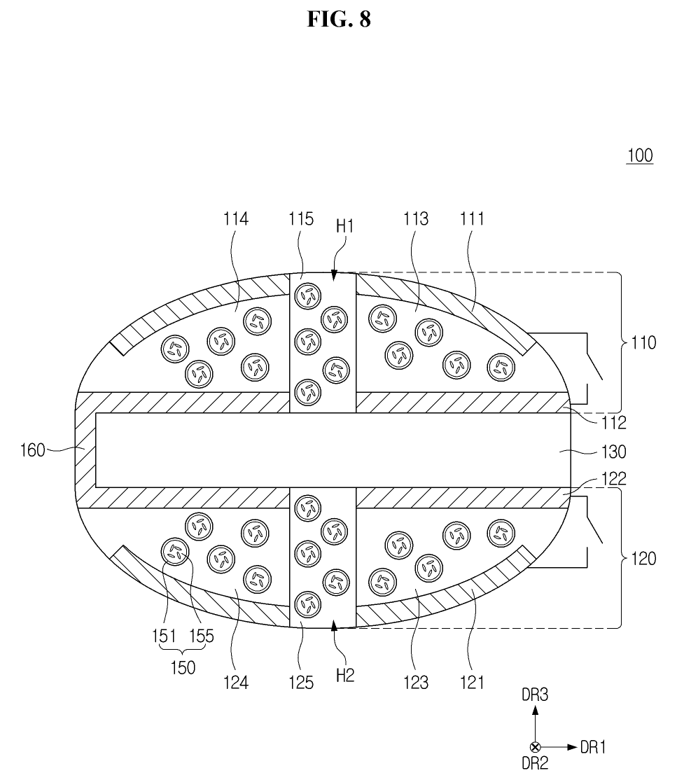

FIG. 8 is a cross-sectional view of a lens structure according to embodiments of the invention.

Referring to FIG. 8, when no voltage is applied to electrodes 111, 112, 121, and 122 by the first voltage (V1) and the second voltage (V2), the liquid crystal molecules 155 arranged in the first variable layers 113 and 114 and the second variable layers 123 and 124 may be randomly aligned. Accordingly, the refractive index of the variable layer 113, 114, 123, and 124 may be substantially the same as the refractive index of the non-variable layers 115 and 125.

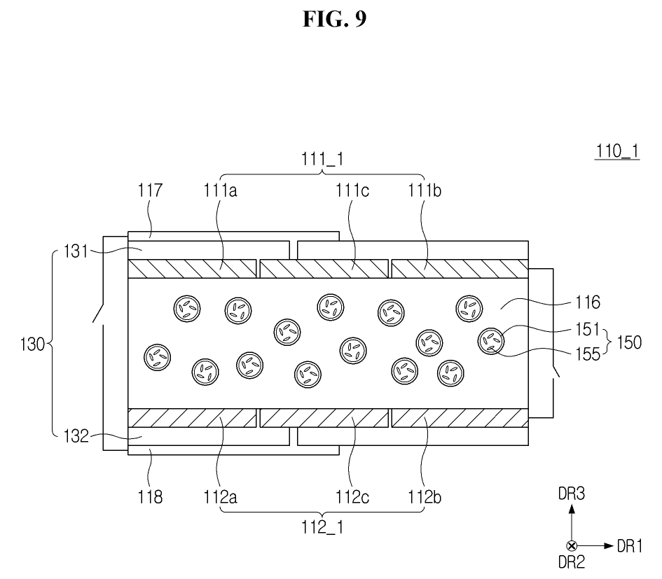

FIG. 9 is a cross-sectional view of a lens structure according to embodiments of the invention.

Referring to FIG. 9, the first lens structure 110_1 according to embodiments of the invention differs from the first lens structure 110 according to FIG. 5 in that it further includes a 1-3 electrode 111c, a2-3 electrode 112c, a fifth electrode 117, and a sixth electrode 118.

The first electrode 111_1 may include a 1-1 electrode 111a, a 1-2 electrode 111b, and a 1-3 electrode 111c, and may be a transparent electrode. The 1-3 electrode 111c may have a circular shape when viewed in a plane where the first direction (DR1) and the second direction (DR2) intersect. However, the embodiments of the invention are not limited thereto, and the 1-3 electrode 111c may have, for example, an oval, a square, a rectangle, a rectangle with rounded corners, or other polygonal shapes.

The 1-1 electrode 111a and the 1-2 electrode 111b are depicted as being separated with the 1-3 electrode 111c in the drawing, but as described above in FIG. 4, they may be integrally connected in a circular ring shape surrounding the 1-3 electrode 111c.

A first insulating layer 131 may be disposed on the first electrode 111_1. The first insulating layer 131 may include a non-conductive material, and the first insulating layer 131 may be transparent or translucent to at least partially transmit light entering the first insulating layer 131. The first insulating layer 131 may be disposed between the first electrode 111_1 and the fifth electrode 117, and may serve to block the electric field between the two electrodes 111_1 and 117.

The first insulating layer 131 may be disposed between the 1-1 electrode 111a and the 1-3 electrode 111c, and may also be disposed between the 1-2 electrode 111b and the 1-3 electrode 111c. When the 1-1 electrode 111a and the 1-2 electrode 111b are formed in a circular ring shape surrounding the 1-3 electrode 111c, the first insulating layer 131 disposed therebetween may also have a circular ring shape surrounding the 1-3 electrode 111c. In this case, the 1-3 electrode 111c may serve to block the electric field between the 1-1 electrode 111a and the 1-3 electrode 111c, and the electric field between the 1-2 electrode 111b and the 1-3 electrode 111c.

A groove that electrically connects the fifth electrode 117 and the 1-3 electrode 111c may be formed in the first insulating layer 131 placed on the 1-3 electrode 111c.

A fifth electrode 117 may be arranged on the first insulating layer 131. The fifth electrode 117 may be a transparent electrode, and may be electrically connected to the 1-3 electrode 111c through the groove of the first insulating layer 131 described above.

The second electrode 112_1, the second insulating layer 132, and the sixth electrode 118 may be arranged symmetrically with respect to the first electrode 111_1, the first insulating layer 131, and the fifth electrode 117, respectively, with respect to the first direction (DR1). The second electrode 112_1, the second insulating layer 132, and the sixth electrode 118 are substantially the same as the first electrode 111_1, the first insulating layer 131, and the fifth electrode 117 described above, and thus, a detailed description thereof will be omitted.

The resin layer 116 may be disposed between the first electrode 111_1 and the second electrode 112_1, and may be in direct contact with the first electrode 111_1 and the second electrode 112_1. The resin layer 116 may include an organic material or resin, and may be transparent or translucent to at least partially transmit light entering the resin layer 116, without being limited thereto.

A capsule structure 150 may be disposed on the resin layer 116, and a plurality of capsule structures 150 may be provided, and thus, the resin layer 116 may serve to bind a plurality of disposed capsule structures 150. The liquid crystal molecules 155 of the capsule structure 150 placed on the resin layer 116 may be randomly aligned when no voltage is applied to the first electrode 111_1 and the second electrode 112_1.

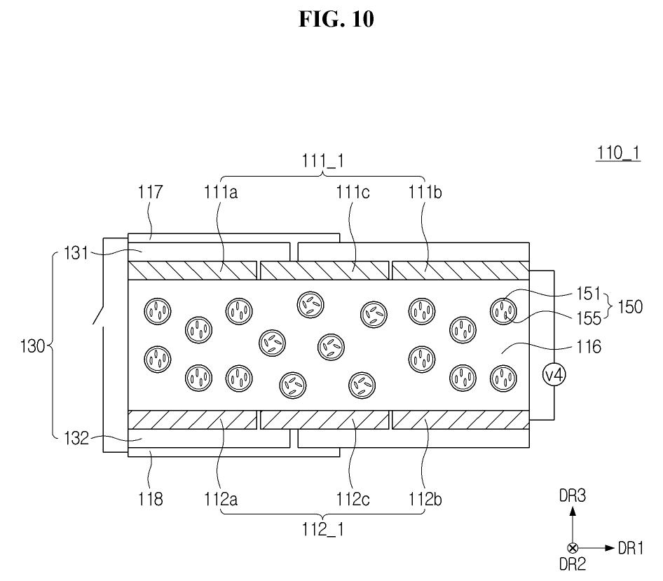

FIG. 10 is a cross-sectional view showing the alignment of liquid crystals in the lens structure according to FIG. 9.

Referring to FIG. 10, the fourth voltage (V4) can be electrically connected to the 1-2 electrode 111b and the 2-2 electrode 112b. The 1-2 electrode 111b may be integrally connected to the 1-1 electrode 111a, and the 2-2 electrode 112b may be integrally connected to the 2-1 electrode 112a. Therefore, when voltage is applied to the 1-2 electrode 111b and the 2-2 electrode 112b by the fourth voltage (V4), the same voltage as the 1-2 electrode 111b may be applied to the 1-1 electrode 111a, and the same voltage as the 2-2 electrode 112b may be applied to the 2-1 electrode 112a.

When voltage is applied to the above electrodes 111a, 112a, 111b, and 112b, the liquid crystal molecules 155 on the resin layer 116 disposed between the 1-1 electrode 111a and the 2-1 electrode 112a, and the resin layer 116 disposed between the 1-2 electrode 111b and the 2-2 electrode 112b may be aligned parallel to the third direction (DR3). Accordingly, the refractive index of the resin layer 116 disposed between the 1-1 electrode 111a and the 2-1 electrode 112a, and the resin layer 116 disposed between the 1-2 electrode 111b and the 2-2 electrode 112b may be lower than the refractive index of the resin layer 116 disposed between the 1-3 electrode 111c and the 2-3 electrode 112c.

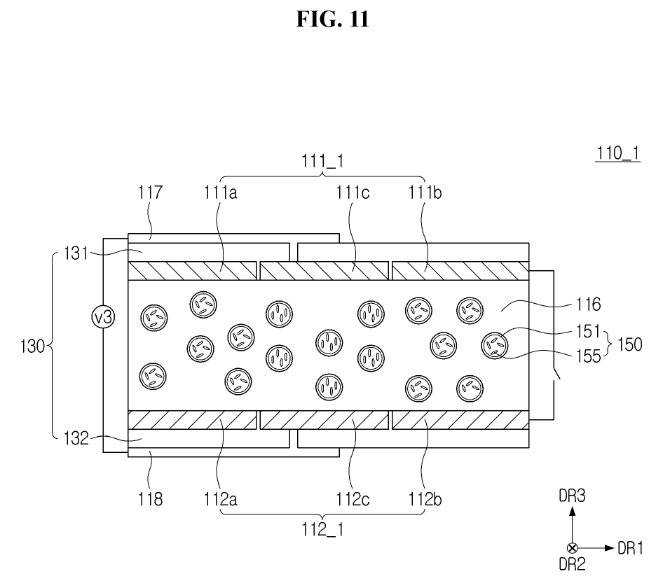

FIG. 11 is a cross-sectional view showing the alignment of liquid crystals in the lens structure according to FIG. 9.

Referring to FIG. 11, the third voltage (V3) may be electrically connected to the fifth electrode 117 and the sixth electrode 118. As described above in FIG. 9, the fifth electrode 117 may be electrically connected to the 1-3 electrode 111c, and the sixth electrode 118 may be electrically connected to the 2-3 electrode 112c.

When voltage is applied to the electrodes 117, 118, 111c, and 112c by the third voltage (V3), the liquid crystal molecules 155 on the resin layer 116 disposed between the 1-3 electrode 111c and the 2-3 electrode 112c may be aligned parallel to the third direction (DR3). Accordingly, the refractive index of the resin layer 116 disposed between the 1-3 electrode 111c and the 2-3 electrode 112c may be lower than the refractive index of the adjacent resin layer 116.

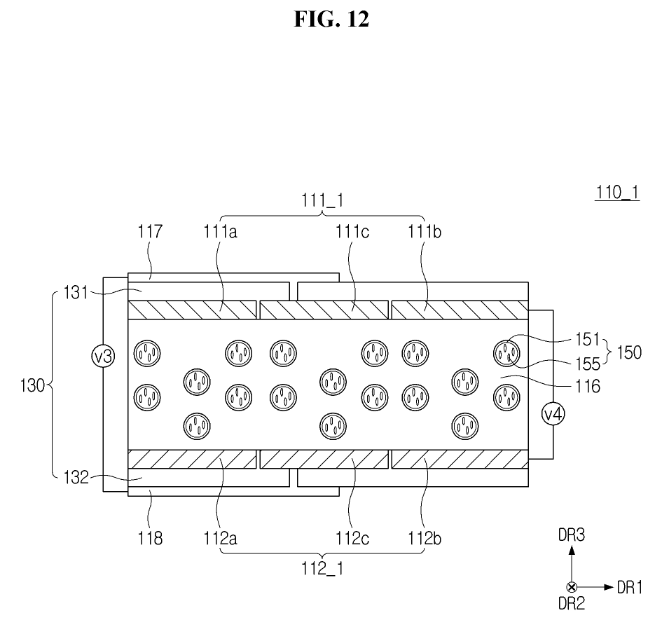

FIG. 12 is a cross-sectional view showing the alignment of liquid crystals in the lens structure according to FIG. 9.

Referring to FIG. 12, when voltage is applied to electrodes 111_1 and 112_1 by the third voltage (V3) and the fourth voltage (V4), the liquid crystal molecules 155 arranged on the resin layer 116 may be aligned parallel to the third direction (DR3).

The magnitude of the voltage applied by the third voltage (V3) may be different from the magnitude of the voltage applied by the fourth voltage (V4). For example, when the magnitude of the voltage applied by the third voltage (V3) is greater than the magnitude of the voltage applied by the fourth voltage (V4), the liquid crystal molecules 155 on the resin layer 116 disposed between the 1-3 electrode 111c and the 2-3 electrode 112c may be aligned more parallel to the third direction (DR3) than the liquid crystal molecules 155 on the adjacent resin layer 116, and therefore, the refractive index of the resin layer 116 disposed between the 1-3 electrode 111c and the 2-3 electrode 112c may be lower than the refractive index of the adjacent resin layer 116.

The display device according to embodiments of the invention may be described as follows.

An electronic device according to embodiments of the invention includes a display device; and a lens structure configured to change the light output from the display device, and the lens structure may include a first electrode, a second electrode facing the first electrode, and a plurality of liquid crystals between the first electrode and the second electrode.

An electronic device according to embodiments of the invention include a display device; and a lens structure configured to change the light output from the display device, and the lens structure may include a first electrode comprising a 1-1 electrode, a 1-2 electrode, and a 1-3 between the 1-1 electrode and the 1-2 electrode, the 1-1, 1-2, and 1-3 electrodes are located on the same line; a second electrode comprising a 1-2 electrode facing the 1-1 electrode, a 2-2 electrode facing the 1-2 electrode, and a 2-3 electrode facing the 1-3 electrode; and a resin layer comprising a capsule structure comprising a plurality of liquid crystals between the first electrode and the second electrode.

The electronic device according to embodiments of the invention may adjust a focal length by changing the refractive index of light output from a display device using a capsule structure including a plurality of liquid crystal molecules.

The electronic device according to embodiments of the invention may correct a user's eyesight by changing the refractive index of light output from the display device using the capsule structure containing the plurality of liquid crystal molecules.

The electronic device according to embodiments of the invention may perform focal length and vision correction functions by changing the refractive index without a separate polarizing plate, thereby preventing a decrease in the brightness of light output from the display device.

The electronic device according to embodiments of the invention may be slimmed down by integrating lenses that perform focal length adjustment and vision correction functions.

The electronic devices according to embodiments of the invention may achieve low power consumption by improving the reduction in brightness of light output from the display device.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. An electronic device comprising:
a display device; and
a lens structure configured to change light output from the display device and comprising:
a first electrode;
a second electrode facing the first electrode; and
a plurality of liquid crystals between the first electrode and the second electrode.

2. The electronic device of claim 1, wherein the lens structure comprises a first lens structure, the first lens structure including the first electrode, the second electrode, a first capsule structure, and a first variable layer disposed between the first electrode and the second electrode, and
wherein the first capsule structure is disposed in the first variable layer.

3. The electronic device of claim 2, wherein the first electrode, the second electrode, and the first variable layer further include a first hole formed therein, and a first non-variable layer disposed in an area at least partially overlapping the first hole.

4. The electronic device of claim 3, wherein the first electrode has a circular ring shape surrounding the periphery of the first hole.

5. The electronic device of claim 3, wherein the first capsule structure includes the plurality of liquid crystals.

6. The electronic device of claim 3, wherein, when a first voltage is applied to the first electrode, the plurality of liquid crystals of the first variable layer are configured to be aligned in a direction perpendicular to the first electrode.

7. The electronic device of claim 6, wherein, when the first voltage is not applied to the first electrode, the plurality of liquid crystals of the first variable layer are configured to be randomly aligned.

8. The electronic device of claim 3, wherein, when a first voltage is applied to the first electrode, the refractive index of the first variable layer is configured to be lower than the refractive index of the first non-variable layer.

9. The electronic device of claim 2, further comprising a second lens structure including:
a third electrode;
a fourth electrode;
a second capsule structure including a plurality of liquid crystals between the third electrode and the fourth electrode;
a second variable layer between the third electrode and the fourth electrode;
a second hole formed in the third electrode, the fourth electrode, and the second variable layer, and
a second non-variable layer disposed in the second hole.

10. The electronic device of claim 9, further comprising an insulating layer disposed between the first lens structure and the second lens structure.

11. The electronic device of claim 9, wherein the second electrode and the fourth electrode are electrically connected.

12. An electronic device comprising:
a display device; and
a lens structure configured to change light output from the display device,
wherein the lens structure comprises:
a first electrode comprising a 1-1 electrode, a 1-2 electrode, and a 1-3 electrode between the 1-1 electrode and the 1-2 electrode, the 1-1, 1-2, and 1-3 electrodes are located on the same line;
a second electrode comprising a 2-1 electrode facing the 1-1 electrode, a 2-2 electrode facing the 1-2 electrode, and a 2-3 electrode facing the 1-3 electrode; and
a resin layer comprising a capsule structure comprising a plurality of liquid crystals between the first electrode and the second electrode.

13. The electronic device of claim 12, wherein the 1-1 electrode and the 1-2 electrode are electrically connected, and the 2-1 electrode and the 2-2 electrode are electrically connected.

14. The electronic device of claim 12, wherein:
the 1-3 electrode is not electrically connected to the 1-1 electrode, the 1-2 electrode, and the 2-3 electrode; and
the 2-3 electrode is not electrically connected to the 2-1 electrode and the 2-2 electrode.

15. The electronic device of claim 14, further comprising:
a first insulating layer; and
a third electrode,
wherein the first insulating layer is disposed on the first electrode, the third electrode is disposed on the first insulating layer, and the third electrode is electrically connected to the 1-3 electrode.

16. The electronic device of claim 15, further comprising:
a second insulating layer; and
a fourth electrode,
wherein the second insulating layer is disposed on the second electrode, the fourth electrode is disposed on the second insulating layer, and the fourth electrode is electrically connected to the 2-3 electrode.

17. The electronic device of claim 16, wherein when voltage is applied to the 1-1 electrode, the 2-1 electrode, the third electrode, and the fourth electrode, the refractive index of the resin layer is configured to be lowered than when voltage is not applied.

18. The electronic device of claim 16, wherein, when voltage is applied to the 1-1 electrode and the 2-1 electrode, and no voltage is applied to the third electrode and the fourth electrode, the refractive index of the resin layer between the 1-1 electrode and the 2-1 electrode, and the refractive index of the resin layer between the 1-2 electrode and the 2-2 electrode are configured to be lower than the refractive index of the resin layer between the 1-3 electrode and the 2-3 electrode.

19. The electronic device of claim 16, wherein, when no voltage is applied to the 1-1 electrode and the 2-1 electrode, and a voltage is applied to the third electrode and the fourth electrode, the refractive index of the resin layer between the 1-1 electrode and the 2-1 electrode, and the refractive index of the resin layer between the 1-2 electrode and the 2-2 electrode are configured to be higher than the refractive index of the resin layer between the 1-3 electrode and the 2-3 electrode.
